(19) United States
(12) Patent Application Publication
(10) Pub. No.: US 2013/0220438 A1
(43) Pub. Date: Aug. 29, 2013

(54) METHOD AND APPARATUS TO REMOVE DEPOSITS

(71) Applicants: Gregory John Hatton, Houston, TX (US); Chien Kuei Tsai, Katy, TX (US)

(72) Inventors: Gregory John Hatton, Houston, TX (US); Chien Kuei Tsai, Katy, TX (US)

(21) Appl. No.: 13/881,298

(22) PCT Filed: Oct. 24, 2011
(86) PCT No.: PCT/US11/57455

§ 371 Date: Apr. 24, 2013

Related U.S. Application Data
(60) Provisional application No. 61/406,667, filed on Oct. 26, 2010.

(51) Int. Cl. F17D 1/08

(52) U.S. Cl. CPC F17D 1/08
USPC 137/15.05

(57) ABSTRACT

A method of producing and transporting crude oil, comprising extracting crude oil from a well; placing the crude oil in a pipeline to transport the crude oil away from the well, wherein at least a portion of the pipeline travels through an atmosphere having an ambient temperature less than 20° C.; and transporting the crude oil for a first time period at a low flow rate so that a precipitate forms on an inner wall of the pipeline; and transporting the crude oil for a second time period at a high flow rate so that the precipitate is cleared from the inner wall of the pipeline.

### BACKGROUND OF INVENTION

PCT Patent Application Publication WO 2010/83095 discloses a subsea production system, comprising a plurality of wells located on a sea floor, the wells producing a fluid comprising hydrocarbons; a cold flow center on the sea floor, the cold flow center fluidly connected to the plurality of wells; and a production facility on land or on a floating structure, the production facility fluidly connected to the cold flow center; wherein the cold flow center lowers a temperature of the fluid and produces a slurry of the fluid and suspended solids for transportation to the production facility. Publication WO 2010/83095 is herein incorporated by reference in its entirety.

U.S. Patent Application Publication US 2006/0186023 discloses a method of transporting a produced fluid through a pipe while limiting deposits at a desired pipe inner-wall location comprising providing a pipe having an inner surface roughness Ra less than 2.5 micrometers at said desired pipe inner-wall location, forcing the produced fluid through the pipe, wherein the produced fluid has a wall shear stress of at least 1 dyne per centimeter squared at said desired pipe inner-wall location. Publication US 2006/0186023 is herein incorporated by reference in its entirety.

U.S. Pat. No. 4,646,837 discloses that solid wax-containing material deposited on pipeline walls, well tubing, etc., are removed by contacting the deposited wax with a mixture of a dispersant-type surfactant and light hydrocarbon at ambient temperatures. U.S. Pat. No. 4,646,837 is herein incorporated by reference in its entirety.

### SUMMARY OF INVENTION

One aspect of the invention provides a method of producing and transporting crude oil, comprising extracting crude oil from a well; placing the crude oil in a pipeline to transport the crude oil away from the well, wherein at least a portion of the pipeline travels through an atmosphere having an ambient temperature less than 20° C.; and transporting the crude oil for a first time period at a low flow rate so that a precipitate forms on an inner wall of the pipeline; and transporting the crude oil for a second time period at a high flow rate so that the precipitate is cleared from the inner wall of the pipeline.

### BRIEF DESCRIPTION OF DRAWINGS

FIGS. 1A and 1B show cross sectional views of a tubular member with deposits formed thereon.

FIG. 2 shows a perspective view of a subsea production system in accordance with embodiments of the present disclosure.

FIGS. 3A, 3B, and 3C show multiple views of an improved tubular member in accordance with embodiments of the present disclosure.

FIG. 4 shows test results of tubular members with varied roughness subjected to varied wall shear stress in accordance with embodiments of the present disclosure.

### DETAILED DESCRIPTION

In one aspect, embodiments disclosed herein relate generally to apparatuses and methods for the transportation of production fluid. Other embodiments disclosed herein may relate to a method and apparatus for managing deposits in systems used to transport production fluid from one or more wellbores. Specific embodiments may provide a tubular member configured for the clean removal of deposits formed on the tubular member, particularly for a tubular member disposed in a subsea environment.

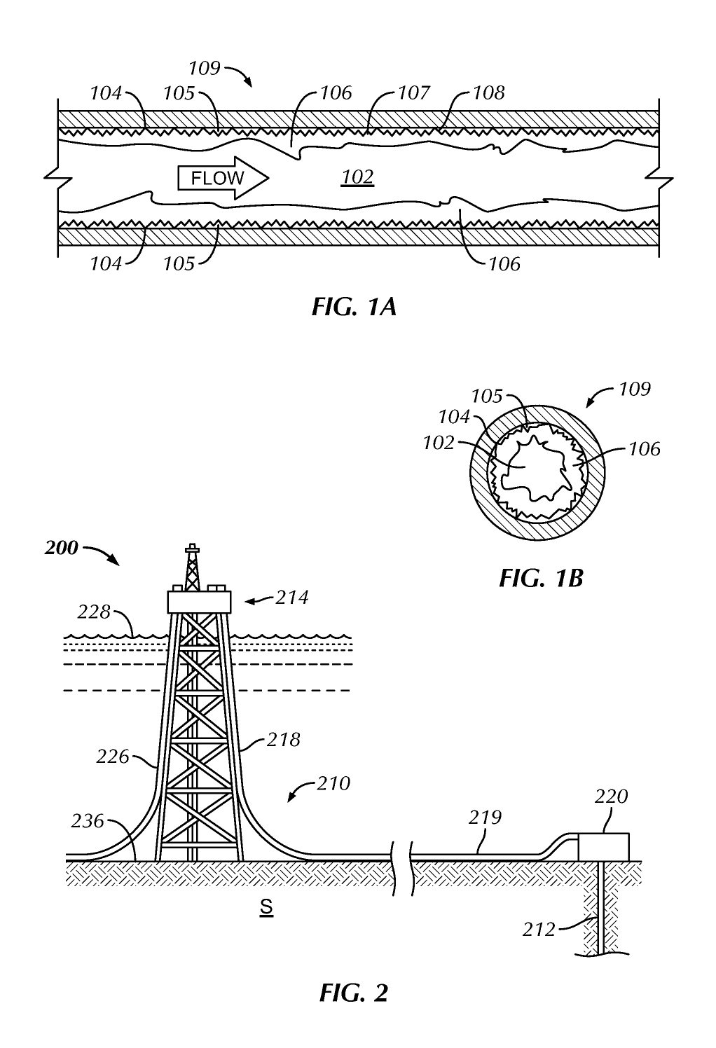

### FIGS. 1A & 1B

Referring to FIGS. 1A and 1B together, cross sectional views of a tubular member with deposits formed thereon are shown. Production fluid may flow into the tubular member 109, such that the production fluid may be transported via the tubular member 109 (or multiple tubular members) from a source to a destination, such as from a wellbore to a production facility (not shown). Some solids may precipitate and/or form deposits that adhere to an inner wall 104 of a tubular member 109. Deposits that have strong adhesive properties to the tubular member 109 may be hard to prevent and/or remove from the tubular member 109.

The deposits 106 may adhere to the inner wall 104 in an amount that is sufficient enough to cause flow through the tubular member 109 to be, at least partially, blocked or constricted. The formation of deposits 106 within the tubular member 109 may be recognized by, for example, an increase in process temperature or pressure indicated on monitoring devices (not shown). The blockage of the tubular member 109 as a result of the deposits 106 may also cause excessive fouling, pressure drop, decreased flow, and decreased thermodynamic efficiencies.

The inner wall 104 of a tubular member 109 may have surface roughness 105, which may include peaks 107, valleys 108, and/or other deviations along the inner wall 104, as shown in exaggeration in FIG. 1A. Once deposits 106 adhere to and fill, for example, between the peaks 107 and the valleys 108, the deposits 106 may adhere to the inner wall 104 over the entire inside surface area of the tubular member 109, making the deposits 106 even more difficult to remove.

Roughness is a measure of the texture of a surface, and is typically representative of the degree of deviations (e.g., size of peaks and valleys) present on the surface. If these deviations are large, the surface is rough; if the deviations are small, the surface is smooth. Generally, the more roughness a surface has, the greater the likelihood of forming deposits, and the greater the difficulty of removing any deposits that adhere to the surface. Consequently, the surface roughness 105 of the tubular member 109 may play a large role in determining how and where any of the deposits 106 form and/or are removed.

Surface roughness may be quantified in several ways. In ASME B46.1-2002, herein incorporated by reference, average surface roughness, Ra, is defined as the arithmetic average of the absolute values of profile height deviations over an evaluation length, as measured from a mean line. As would be known to a person having ordinary skill in the art, the average roughness for a standard tubular member used in production systems as described herein may be on the order of about 1800 micro-inches or more.

As a result of strong adherence of deposits, flow shear that acts on the deposits 106 may not be sufficient enough to remove the deposits 106, either partially or entirely. As known to a person of ordinary skill in the art, flow shear (i.e., shear stress, τ) is used to define the force per unit area (i.e., the area of surface subjected to the force) that is required to sustain a constant rate of fluid movement. When the cohesive strength of the deposits (i.e., the ability of the deposits to remain bonded or connected to a surface) is less than the adhesion strength (i.e., the force required to separate the deposits using shear or tensile stress), and wherein the inner wall has a standard roughness (or higher), the flow shear may break off flow-exposed portions of the deposit into the flow and/or leave the remaining deposit in void spaces not in the inner wall topography. Moreover, as the flow shear required to prevent deposits increases, it may be necessary to increase production flow rates beyond preferred operating rates.

In accordance with the present disclosure, any solids or deposits that form within and/or adhere to the inner wall of a tubular member may be efficiently and effectively managed. In some embodiments, deposits may be prevented from forming on the inner wall, while in other embodiments, deposits that form may be cleanly removed from the inner wall, as will now be explained.

### FIG. 2

Referring to FIG. 2, a perspective view of a subsea production system in accordance with embodiments disclosed herein, is shown. The extraction of production fluids from a subterranean formation may be accomplished, for example, through the use of the subsea production system 200 illustrated in FIG. 2. The subsea production system 200 of the present disclosure may include a wellbore 212 drilled into a subsea formation, S, and in fluid communication with a surface facility 214. Although surface facility 214 is shown as a fixed platform, other facilities such as TLP's, semi-sub's, spars, FPSO's, and other offshore production facilities may be used with this invention.

The wellbore 212 may be operatively connected to, and in fluid communication with, the surface facility 214 via a pipeline 210 (e.g., piping, tubing, conduit, etc.). The pipeline 210 may include various sections, such as a seafloor section 219 and/or a riser section 218, each of which may be of any necessary length to establish fluid communication between the wellbore 212 and the surface facility 214, as would be understood by a person of ordinary skill in the art. In one embodiment, the riser section 218 may run into deep water depths, while the seafloor section 219 may extend along a seabed floor 236 and may terminate at the wellhead 220. For example, the riser section 218 may run into water depth that may be in excess of 3000 feet, for example 5000 to 10,000 feet, while the length of the seafloor section 219 along the seabed floor 236 may be in excess of 10,000 feet, for example several miles or more.

The subsea production system 200 may also include an export pipeline 226 that may be configured to transport production fluid from the wellbore 212 and/or surface facility 214 to another location, such as a second surface facility (not shown) or to the shore. Those of ordinary skill in the art will appreciate that the second surface facility may be any production fluid receiving facility, such as a land rig or a floating, production, storage, and offloading (“FPSO”) vessel. The pipeline 210, export pipeline 226, and/or any other conduit (e.g., piping, flowline, bypass line, jumper line, etc.) associated with the subsea production system 200 may include one or more tubular members (not shown) coupled together.

Production fluid may be extracted from the wellbore 212, which may be located at great distances below a surface of the ocean 228. In addition to any hydrocarbons that may be present in the form of liquid and gaseous hydrocarbons, the production fluid may also contain other components, such as water, brine, etc. The production fluid from the wellbore 212 may also include dissolved solids such as waxes, hydrates, asphaltenes, organic and inorganic salts.

At high temperatures and/or low pressures, the dissolved solids may remain in solution. However, a person having ordinary skill in the art will recognize that the ambient temperature of the ocean water that surrounds the wellhead 220 and/or any process piping may be lower than the temperature of the fluid produced from the wellbore 212. In some embodiments, piping within system 200 may be exposed to cooler ambient temperatures that may be as cold as 40° F., and in some cases even lower. Any dissolved solids that precipitate and/or deposits that form may be managed in accordance with embodiments disclosed herein.

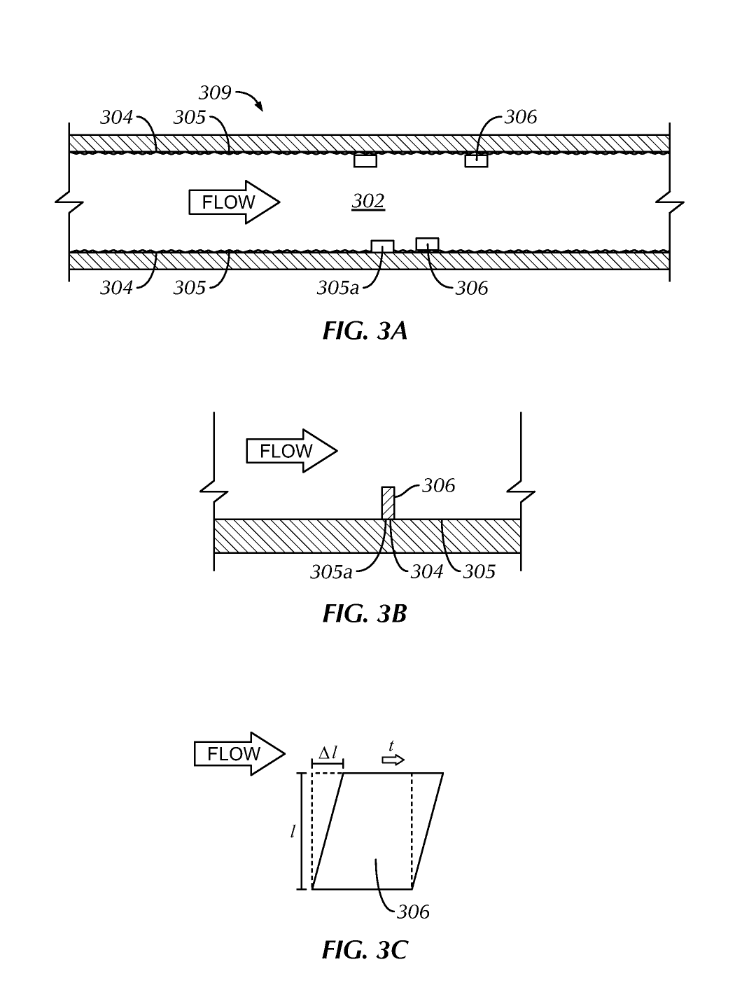

### FIGS. 3A, 3B, & 3C

Referring now to FIG. 3A, a cross sectional view of an improved tubular member 309 in accordance with embodiments disclosed herein, is shown. The tubular member 309 may be any tubular member used in the transport of fluids (e.g., flowlines, conduits, pipes, tubes, etc.), including any tubular member associated with subsea production system (200, FIG. 2). As shown in FIG. 3A, the tubular member 309 may include an annular flowbore 302 configured for production fluid to flow therethrough, as illustrated by the directional arrow.

The design of the tubular member 309 may be based on factors that include, but are not limited to, expected ambient temperature, production fluid temperature and pressure, production fluid composition, precipitate and hydrate forming temperatures and pressures, and thermal and mechanical properties of the tubular member 309 (e.g., surface chemistry, length, diameter, etc.). In some embodiments, the tubular member 309 may have a reduced or lower surface roughness 305, that allows the deposits 306 to be cleanly removed from the inner wall 304. In an exemplary embodiment, the average surface roughness, Ra, of the tubular member 309 may prevent the adherence of any deposits 306 to the inner wall 304 of the tubular member 309.

In accordance with the present disclosure, significant reduction or elimination of the surface roughness 305 may decrease the amount of flow shear required to remove deposits 306 from the tubular member 309. While a standard carbon steel tubular member used in subsea applications may have an average surface roughness of approximately 1800 micro-inches or more, embodiments of the present application may include an average surface roughness, Ra, that is less than 1000 micro-inches, or less than about 500 micro-inches. For more precipitant-inert and precipitant-phobic surfaces, the surface roughness requirement may be less severe, such that the average surface roughness, Ra, may be less than 1400 micro-inches.

Thus, the tubular member 309 may be designed with an average surface roughness, Ra, that may be smoother than standard tubular members normally used in subsea applications. To provide the tubular member 309 with a smoother surface, the tubular member 309 may be fabricated, for example, from a tubular member that initially has a standard average roughness. However, the roughness may be reduced via a finishing process, such as electro-polishing. Other embodiments disclosed herein may include the tubular member 309 treated with an application of coatings on the inner wall 304. Although these examples are provided for understanding of the disclosure, how the surface roughness 305 is reduced is not meant to be limited, and the surface roughness 305 may be reduced in other ways as would be understood to a person having ordinary skill in the art.

Referring to FIGS. 3B and 3C together, close-up views of a smooth inner wall 304 with a deposit 306 formed thereon in accordance with embodiments disclosed herein, are shown. As production fluid moves through the tubular member 309 (FIG. 3A) and along the inner wall 304, solids may precipitate and deposits 306 may adhere to the inner wall 304. FIG. 3C illustrates an example of deformation that results from flow shear acting against the deposit 306 adhered to the inner wall 304.

In accordance with embodiments disclosed herein, an increase of the fluid flow rate through the tubular member 309, and therefore an increase of the flow shear along the inner wall 304, may prohibit and/or clean any deposits 306 that may adhere to the inner wall 304. The change in the flow rate may be accomplished, for example, by the opening of a valve, a reduction of pressure (topside), or any other process control operation known to a person having ordinary skill in the art. An increase in flow rate of production fluid may also increase the amount of wall shear stress, τ_{w}, that occurs at a deposit-wall interface 305a. The wall shear stress, τ_{w}, may be defined, for example, as the component of flow shear that is applied parallel or tangential to the inner wall 304.

Because the inner wall 304 may be configured with decreased surface roughness 305 (i.e., a smoother surface), the wall shear stress, τ_{w}, may remove the entire deposit 306 from the inner wall 304. Once removed, the deposits 306 may no longer disrupt or prevent flow of production fluid through the tubular member 309. In other words, the inner wall 304 may be configured with a predetermined surface roughness 305, such that the wall shear stress, τ_{w}, that acts against the deposit 306 is sufficient to overcome the total adherence of the deposit 306 to the inner wall 304, and may substantially clean and/or rid the inner wall 304 of any deposits 306 formed thereon.

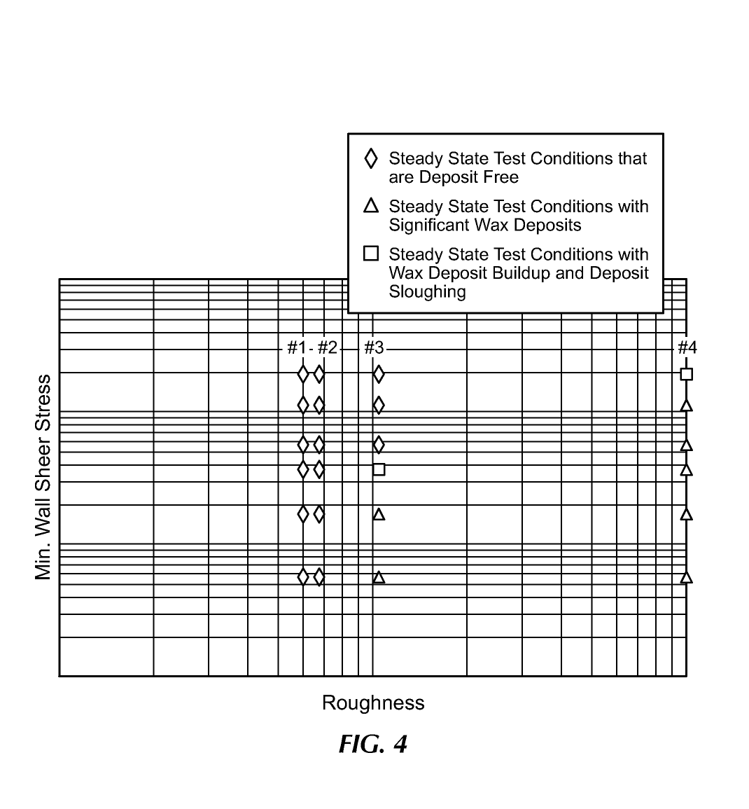

### FIG. 4

Referring now to FIG. 4, a map developed from the test results of tubular members with varied roughness subjected to varied wall shear stress in accordance with embodiments disclosed herein, is shown. Various tests were conducted with crude oil at conditions under which wax may precipitate and/or form deposits on a standard steel pipe. The test pipes included oil and gas industry standard steel pipe, steel pipes with varied inner wall roughness, and pipes having internal coatings thereon. FIG. 4 summarizes the results of four separate tests performed on tubular members with different roughness. Each of the four tests was conducted with a single test pipe having a fixed roughness and which was subjected to a range of flow rates that resulted in a range of wall shear stress.

As shown in FIG. 4, Tests #1 and #2 show roughness and wall shear stress combinations that resulted in no deposition buildup during steady-state flow. Tests #3 and #4 show surface roughness and wall shear stress combinations that resulted in deposition buildup during steady-state flow conditions.

Tests #3 and #4 show data points both above and below a median, which is broadly representative of a transition region where deposits may form and remain adhered to the inner wall. For example, Test #3 was initially started with a steady-state flow that resulted in low wall shear stress. At the low shear stress, deposits formed and remained, even as the wall shear stress was slightly increased. Test #3 also illustrates that no deposits formed with steady-state flow at high wall shear stress with the same inner wall roughness. In the transition region (i.e., near the median), deposits formed and then sloughed.

Test #4 further illustrates the proportional relationship between roughness and wall shear stress. With a tubular member configured with increased roughness, a test similar to Test #3 was conducted by varying the wall shear stress. As before, deposits formed when the wall shear stress was low. Deposits remained even as the wall shear stress was increased to and above the region of the intermediate wall shear stress of Test #3. Finally, as the wall shear stress was increased further, the deposits sloughed, and then cleared.

Different production fluids and/or systems may have different deposition tendencies, and may require different combinations of roughness and shear stress to prohibit and/or remove deposits. As shown by FIG. 4, for production flow rates with lower wall shear stress, the roughness necessary to prevent deposits is smaller than the roughness requirement for production flow rates with higher shear stress.

Accordingly, embodiments disclosed herein may include one or more of the following advantages. Improved tubular members of the present disclosure may advantageously provide for the transport of produced fluids through tubular members with substantially reduced deposits. A combination of a smoother surface and a controlled wall shear stress may substantially reduce and/or eliminate deposits that form on the tubular member. For a very smooth surface, the wall shear stress required to prevent deposits is lower than for standard tubular members, such that the flow rate through the system may beneficially be maintained below maximum capacity and/or design rates. The reduction of deposits in tubular members may lessen the needed frequency of cleaning (i.e., pigging, mechanical scraping, etc.) or other activities that require downtime. Therefore, the embodiments disclosed herein provide a system yielding increased production of valuable hydrocarbons.

### ILLUSTRATIVE EMBODIMENTS

In one embodiment, there is disclosed a method of producing and transporting crude oil, comprising extracting crude oil from a well; placing the crude oil in a pipeline to transport the crude oil away from the well, wherein at least a portion of the pipeline travels through an atmosphere having an ambient temperature less than 20° C.; and transporting the crude oil for a first time period at a low flow rate so that a precipitate forms on an inner wall of the pipeline; and transporting the crude oil for a second time period at a high flow rate so that the precipitate is cleared from the inner wall of the pipeline. In some embodiments, the pipeline has a surface roughness less than 0.025 mm on the inner wall. In some embodiments, the atmosphere has a temperature less than 15° C. In some embodiments, the atmosphere comprises a salt water marine environment, such as a sea or ocean. In some embodiments, the pipeline has a surface roughness less than 1000 microinches on the inner wall. In some embodiments, the pipeline has a surface roughness less than 500 microinches on the inner wall. In some embodiments, the pipeline has a surface roughness between 25 and 400 microinches on the inner wall. In some embodiments, the first time period is at least one week. In some embodiments, the second time period is less than one day. In some embodiments, the method also includes transporting the crude oil for a third time period after the second time period at a low flow rate so that a precipitate forms on an inner wall of the pipeline. In some embodiments, the low flow rate creates a wall shear stress of less than 10 dyne per centimeter squared at the inner wall. In some embodiments, the high flow rate creates a wall shear stress of greater than 10 dynes per centimeter squared at the inner wall. In some embodiments, the high flow rate creates a wall shear stress of between 20 and 1000 dynes per centimeter squared at the inner wall. In some embodiments, the high flow rate creates a wall shear stress of between 50 and 500 dynes per centimeter squared at the inner wall.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

1. A method of producing and transporting crude oil, comprising:
extracting crude oil from a well;
placing the crude oil in a pipeline to transport the crude oil away from the well, wherein at least a portion of the pipeline travels through an atmosphere having an ambient temperature less than 20° C.; and
transporting the crude oil for a first time period at a low flow rate so that a precipitate forms on an inner wall of the pipeline; and
transporting the crude oil for a second time period at a high flow rate so that the precipitate is cleared from the inner wall of the pipeline.

2. The method of claim 1, wherein the pipeline has a surface roughness less than 0.025 mm on the inner wall.

3. The method of claim 1, wherein the atmosphere has a temperature less than 15° C.

4. The method of claim 1, wherein the atmosphere comprises a salt water marine environment, such as a sea or ocean.

5. The method of claim 1, wherein the pipeline has a surface roughness less than 1000 microinches on the inner wall.

6. The method of claim 1, wherein the pipeline has a surface roughness less than 500 microinches on the inner wall.

7. The method of claim 1, wherein the pipeline has a surface roughness between 25 and 400 microinches on the inner wall.

8. The method of claim 1, wherein the first time period is at least one week.

9. The method of claim 1, wherein the second time period is less than one day.

10. The method of claim 1, further comprising transporting the crude oil for a third time period after the second time period at a low flow rate so that a precipitate forms on an inner wall of the pipeline.

11. The method of claim 1, wherein the low flow rate creates a wall shear stress of less than 10 dyne per centimeter squared at the inner wall.

12. The method of claim 1, wherein the high flow rate creates a wall shear stress of greater than 10 dynes per centimeter squared at the inner wall.

13. The method of claim 1, wherein the high flow rate creates a wall shear stress of between 20 and 1000 dynes per centimeter squared at the inner wall.

14. The method of claim 1, wherein the high flow rate creates a wall shear stress of between 50 and 500 dynes per centimeter squared at the inner wall.
